(19) United States
(12) Patent Application Publication
(10) Pub. No.: US 2012/0327045 A1
(43) Pub. Date: Dec. 27, 2012

(54) DEVICES AND PROCESSES FOR MANUAL DATA INPUT

(76) Inventor: Peter James Skinner, Montclair, NJ (US)

(21) Appl. No.: 13/340,416

(22) Filed: Dec. 29, 2011

Related U.S. Application Data
(60) Provisional application No. 61/429,278, filed on Jan. 3, 2011.

(51) Int. Cl. G06F 3/033

(52) U.S. Cl. 345/179

(57) ABSTRACT

Devices are disclosed for manually inputting data to an electrically-sensitive user interface, which devices comprise a device body and an interface-contacting member supported by the body, the interface-contacting member comprising a resilient material having a convex interface-contacting surface with at least one recess formed therein; processes for manual data input are also disclosed.

### PRIORITY INFORMATION

The priority of U.S. Provisional Application No. 61/429,278, filed Jan. 3, 2011, is claimed, the subject matter of such provisional application being incorporated herein by reference.

### FIELD OF THE INVENTION

The present invention concerns the input of data to an electronically-sensitive user interface, such as the screen for a tablet personal computer, mobile telephone, or hand-held data processing device.

### BACKGROUND OF THE INVENTION

Devices with electrically-sensitive user interfaces are becoming increasingly popular because they accommodate the incorporation of familiar pencil-and-paper functions into a user's interaction with the device. By way of example, a tablet personal computer allows a user to interact with the computer by writing on it, without sacrificing the power or utility of its operating system and/or various desktop applications. Simply put, users are able to take notes in their own handwriting, similar to taking handwritten notes with a pencil and paper, while still realizing the benefits of computerization. Moreover, users are able to interact directly with the regions of interest on the computer and thus more intuitively, as opposed to traditional computer input devices (mouses and trackpads) which do not interact directly with the screen and instead rely on a virtual representation (such as a cursor or arrow) to indicate screen position.

The aforementioned devices provide many features found in word processor and other personal computer software, for instance, sharing of notes among meeting participants in real-time during the meeting via a wireless communication link. And there are additional advantages, such as the ability to search notes for particular words, and the ability to input information in other ways including speaking. These advances are beyond the capabilities of pencil and paper.

Users of tablet personal computers and other such devices commonly write on the device's display area with a stylus or pen. However, conventional styli or pens typically have a writing tip made of hard plastic. The interaction with writing surfaces can be undesirably hard, slippery and noisy. While there are some conventional tips made of a soft polymer material, the interaction with many writing surfaces is still undesirable due to the incapacity of the soft polymer to conform to the interface surface.

More specifically, a drawback of such prior technology is its incapacity for reliably proportionate response to the exertion of force thereon, such that the desired extent of contact with the interface (hereinafter, sometimes, “contact footprint”) is overshot or undershot due to the tip's lack of responsiveness. Furthermore, apart from this responsiveness deficit, conventional tip materials can be insufficiently compliant to conform to the contours of the interface surface (such conformity hereinafter, sometimes, “surface contour conformability”).

For instance, as recognized in U.S. Pat. No. 5,877,459 (the “459 patent”), concerning a capacitive pen/tablet system, most of the capacitance effect is produced by a relatively small area of physical contact of the pen tip with the tablet insulator coating. The patentees further observe that, in general, the larger this contact area the larger will be the signal that is coupled to the tablet from the pen, and that when utilizing a rigid pen tip this capacitance is determined largely by the geometry of the pen tip, the geometry of the tablet, and the materials used in the pen tip and the tablet.

In the 459 patent, U.S. Pat. No. Re. 34,095 is said to teach a digitizer stylus having a tablet-engaging pen refill, and a movable plunger that is made of resilient material having a rounded surface that is deformed to increase the area of contact with a board as pressure on the stylus increases. But, the patentees conclude that the need remains for an electrostatic pen comprising an electrically conductive and flexible tip to enable an increased capacitor-electrode contact area with a digitizing tablet as the tip is pressed down onto the tablet. Thus, there is proposed in the 459 patent a manually operable electrostatic pen having a tapered tip that is both electrically conductive and flexible. The pen tip is taught to be an electrically conductive felt, which is deformable such that its contact area on the tablet increases as a function of an increasing manual force pushing the tip down onto the tablet, with the electrical signal increasing in magnitude as a function of increases in the contact area. The flexible pen tip is said to deform for the purpose of increasing the area of contact to a dielectric tablet, thus increasing the area of the top plate or electrode of the capacitor that is formed by the pen tip and the tablet. An additional advantage is said to be that the material from which the tip is formed may have a coefficient of friction whereby writing on the tablet, and concomitantly the feel or tactile feedback of the pen, are desirably managed.

Nevertheless, although the 459 patent purports to disclose an improved contact footprint of the tip on an interface surface whereby the footprint increases with increased force pressing the tip against the surface, it is not a panacea. The disclosure does not contain teaching on how a selected contact footprint can reliably be obtained and maintained during use of the interface-contacting member, and further how to deliver contact footprints of differing area, the magnitude of each being commensurate with the magnitude of force exerted on the tip.

More recently, in U.S. Pat. No. 6,771,254 (the “254 patent”) it has countervailingly been suggested that a nib be formulated from a substrate material that approximates a desired nib-and-writing-surface firmness and a secondary material added to the nib substrate material to produce a desired amount of friction between the nib and the writing surface. For instance, according to the 254 patent, the nib substrate material may be a porous material impregnated with a dry lubricant or Teflon such as a Teflon fiber and one or more additional types of fiber including Nylon, cellulose acetate, and/or polyester, with the secondary material comprising a fiber wrap, optionally including Teflon, surrounding the nib substrate material.

However, the 254 patent's technology is disadvantageously limited. This is because the technology in question features a nib which, when in contact with an interface surface, is selected for mechanical simulation of the firmness and friction level of pencil on paper. Indeed, in the patent it is disclosed that many factors, such as stiffness, static friction, dynamic friction, sound, texture and the like, affect the accuracy of the simulation of pen and paper interaction. While the patentees acknowledge that managing all of those properties is not practical, they teach that their nib designs are focused on two of the relatively more important parameters: nib stiffness and friction between the nib and an intended writing surface. Such an approach fails to address the coincident attainment of important desiderata, namely, a nib that is electrically interactive with a user interface, has a readily controllable contact footprint, and exhibits a high level of surface contour conformability. The 254 patent's focus instead on factors geared toward simulating a pencil on paper interaction indicates an absence of appreciation on the patentees' part for how to achieve those desiderata.

Accordingly, a data input function which is more reliable in reflecting the information being introduced, and more responsive to differences in the information being introduced, would be a significant advance.

### SUMMARY OF THE INVENTION

It is an object of the invention to provide a robust and accurate data input function.

It is another object of the invention to provide a data input device and method for reliably communicating the information intended to be introduced.

It is still another object of the invention to provide a data input device and method responsive to differences in the information being introduced such that differentiable signals are communicated for data processing.

A device for inputting data to an electrically-sensitive user interface comprises a device body; and an electrically-sensitive interface contacting member supported by the body; the interface-contacting member comprising a resilient material having a continuous convex interface-contacting surface; the interface-contacting surface having at least one recess formed therein.

A process for inputting data to an electrically-sensitive user interface, comprises providing a device having a device body and an electrically-sensitive interface contacting member supported by the body, the electrically-sensitive interface contacting member comprising a resilient material having a continuous convex interface-contacting surface having at least one recess formed therein; pressing the interface-contacting surface of the electrically-sensitive interface contacting member against a surface of an electrically-sensitive user interface such that the resilient material of the electrically-sensitive interface contacting member is compressed into the recess thus facilitating deformation of the interface-contacting surface to conform to the surface of the electrically-sensitive user interface; and inputting data to the electrically-sensitive user interface through an electrical interaction of the interface-contacting surface of the electrically-sensitive interface contacting member with the surface of the electrically-sensitive user interface.

Substantial advantages accrue to the practitioner of the invention. Thus, data input is readily achieved through a rugged and versatile technology, which is conveniently deployed. There are few if any movable parts, and the technology is suitable for use across the whole spectrum of data processing devices comprising an electrically sensitive user interface for receiving manual data input. Data input is precise because the tip of the input device is easily and repeatedly deformable by the exertion of manual pressure thereon to press the tip against a user interface surface so as to achieve the contact area sought by the user. Data input is reliable since the desired contact area can be attained over a wide range of angles at which the interface contacting member addresses the user interface surface, and the desired contact area can be maintained even if such angle of address is varied (intentionally or unintentionally) during use. Furthermore, because the tip of the input device is highly responsive to the amount of force exerted to press it against the user interface surface, the contact area between the tip and that surface varies correspondent with differences in the force exerted to press the tip against the surface. Accordingly, the invention is effective to produce a gradient of different contact areas corresponding to different amounts of force exerted as aforesaid.

### FIGURES OF DRAWING

FIG. 1 is a perspective view of a device for inputting data to an electrically-sensitive user interface.

FIG. 2 is side plan view of the device of FIG. 1.

FIG. 3 is a sectional view of the device of FIGS. 1 and 2 taken along the line 3-3 of FIG. 2.

FIG. 4 is an enlarged view corresponding to the portion 4 of FIG. 3.

FIG. 5 is an end plan view of an interface contacting member of the device of FIGS. 1-4.

### DETAILED DESCRIPTION OF CERTAIN PREFERRED EMBODIMENTS

A central feature of the invention is the incorporation in the interface-contacting member of a tip which is resiliently deformable in response to force pressing the tip against the electrically-sensitive user interface surface. In this manner, an area of contact between the tip and the surface is formed. The magnitude of the area of contact varies with the amount of force pressing the tip against the surface. By adjusting such force from one value to another, different desired areas of contact and concomitantly different responses to contact can be achieved.

The tip is formed of an appropriately resilient material. Moreover, the tip material's conductive properties must be such that it can interact electrically with the interface. In one embodiment, the interface-contacting member's tip comprises an electrically conductive or electrically semiconductive material. In another embodiment, the interface-contacting member's tip comprises a material with high relative permittivity. For the present application, the terms conductive and conductivity shall include within their meaning relative permittivity. In various good embodiments of the invention the tip material is also one which exhibits an adequately low coefficient of friction between it and the material of the user interface surface that it slides easily over such surface.

However, the tip material's resiliency and conductivity are necessary but not sufficient conditions for practicing the invention. That is to say, the tip should also be deformable so that when pressed against a user interface surface due to the exertion of force by a user an area of contact between the tip and the surface is achieved. To obtain this result in accordance with the invention, the tip material itself must exhibit elasticity, and further the tip must incorporate one or more recesses into which the elastic material can expand to confer the desired deformability. The invention is not revealed through aspirational discussion in the 459 patent to the effect that under differing magnitude forces a tip deforms to provide variably sized areas of contact with the upper surface of a user interface's insulating layer, such area increasing as a function of an increasing manual force, whereby the tip is pushed onto the upper surface of the insulating layer. Nor is the invention put into possession of the art by notional observation that the signal provided to an associated signal detector increases in magnitude as a function of an increase in such contact area and the resulting increase in the capacitance value of the aforementioned capacitor. To the contrary, with interface systems involving detection of a signal based on capacitance, the reliability of such signal, and thus the effectiveness of the data input function, vary with the tip's capacity for deformation. The desired precision of response, which will enable dependably varying the area of contact between the tip and the user interface as a function of the amount of force applied, requires the coincident utilization of the tip material having the aforementioned mechanical and conductive properties, and provision in the tip of one or more recesses permitting internal material displacement. In combination with the previously discussed mechanical and conductivity properties, provision of a recess, preferably a plurality of recesses, in the top is critical to securing the desired precision of response. The resilient elastic tip material expands into the recess void space, thus aiding deformation and making the tip more sensitive to differing levels of applied force in yielding different areas of contact with the interface.

Therefore, in accordance with the invention, the tip material has mechanical properties, which not only contribute to the selective attainment of different areas of contact depending on the force applied, but also such material's expansion into the tip's recess(es), thereby aiding the tip's deformation to the desired extent. This materially increases the reliability of attaining a desired area of contact, and the responsiveness of the tip in yielding different areas of contact when subjected to differing amounts of force pressing the tip against a user interface surface.

The specific identity of the tip material is not critical to the invention as long as the material has the desired mechanical properties to provide adequate resiliency and deformability for repeated pressing against the user interface surface such that a range of different areas of contact between the tip and the interface can be attained, along with the desired conductivity properties to permit electrical interaction with the user interface. Such materials, in and of themselves, and their suitability for tip formation are known. For instance, see the aforementioned 459 patent, in which it is disclosed that many conductive elastomers are available for use as the tip material. Thus, for instance, the tip material can suitably be rubber or a resilient plastic in which particles of carbon or other electrically conductive or electrically semiconductive material are embedded. Similarly, in embodiments which further involve a sufficiently low coefficient of friction between the tip material and the material of the user interface surface that the tip slides easily over such surface, the specific identify of the tip material is not crucial—as long as its mechanical properties are adequate to confer the desired additional behavior as well. Once in possession of the teachings herein, those of ordinary skill in the art will be able to determine empirically a proper formulation for the tip material. This will not require innovation rising to the level of further invention, and rather will be a matter of routine experimentation.

In preferred embodiments of the invention, the invention involves the capacitance-based inputting of data. More specifically, in these embodiments the electrical coupling between the data input device and the data processing device is capacitive. The user interface of the data processing device is capable of sensing the presence of a capacitively-coupled load, ground or signal source. Accordingly, for instance, when the tip is pressed against the user interface surface the tip material becomes a plate of and thereby forms a capacitor (as evident from the prior literature, such as the 459 patent, a typical electrically-sensitive user interface, such as a digitizing tablet, will be understood by those skilled in the art as meaning a unit comprising an upper non-conductive surface and an underlying conductive layer, which acts as the capacitor's opposite plate). The data processing device can sense the condition, or a change in the condition, of the thus-formed capacitor in order to effect data input. It goes almost without saying that the embodiments discussed above are not the only capacitive technology to which the invention can be applied. Other types of capacitance-based developments can also be brought into conformity with the invention. This includes: a development in which the user interface incorporates a capacitor and the stylus is brought into contact therewith whereby the capacitor's stored charge can flow into the stylus and the change in stored charge detected (such as the development referenced in U.S. Pat. No. 4,707,845); as well as another development in which the user interface incorporates an underlying electrical conductive layer and supported on the upper surface thereof an electrically insulating layer, the stylus comprising a signal source and being brought into contact with the electrically insulating layer of the user interface whereby a capacitor is formed, the stored charge of which is attenuated by current flow from the signal source to a plate of the capacitor, and the attenuated stored charge is detected (such as the development referenced in the 459 patent).

The interface-contacting member of the invention comprises not only a tip as disclosed in preceding passages, but further a barrel or other tubular portion (typically cylindrical, but cross-sections of other shapes can also be utilized) by which the members can be grasped. The tubular grasping portion may be hollow or solid. Depending on the system adopted for electrical coupling of the tip material with the user interface, the member's barrel or other tubular portion can be formed of an electrically conductive or electrically semiconductive material, for instance, aluminum or other metal. This permits the barrel or other tubular portion to be electrically coupled to the tip component and/or the body of a user. Optionally, the barrel or other tubular portion's constituent conductive or semiconductive material can be covered by a non-conductive material, such as the coating produced by anodizing a metal. Alternatively, in certain good embodiments of the invention it is advantageous to form the barrel or other tubular portion of a non-conductive material, preferably covered by an electrically conductive or electrically semiconductive material.

Another advantageous feature of the invention is the configuration of the tip so as to have a continuous convex interface-contacting surface. Due to this feature, and the responsively deformable and resilient nature of the tip material in conjunction with the one or more recesses in the tip, a desired contact area can be achieved at a range of angles between the interface-contacting member and the user interface surface, i.e., the angle of tilt. Moreover, as a consequence of those attributes, the desired contact area can be maintained even if the angle of tilt (between such member and the user interface surface) changes during use. This change frequently occurs because, when the member is held in the hand of the user, pressed against the interface surface, and moved to input data, the orientation of the member vis-à-vis the interface surface can vary from one moment to the next. But, even in the event the angle of tilt does change during use, the elasticity and resiliency of the tip material taken together with the tip's recess(es) are such that, while the constituent tip material actually in contact with the interface surface may be adjusted (at least in part) to compensate, the overall area of contact between the tip and the interface surface will remain constant or at least substantially constant.

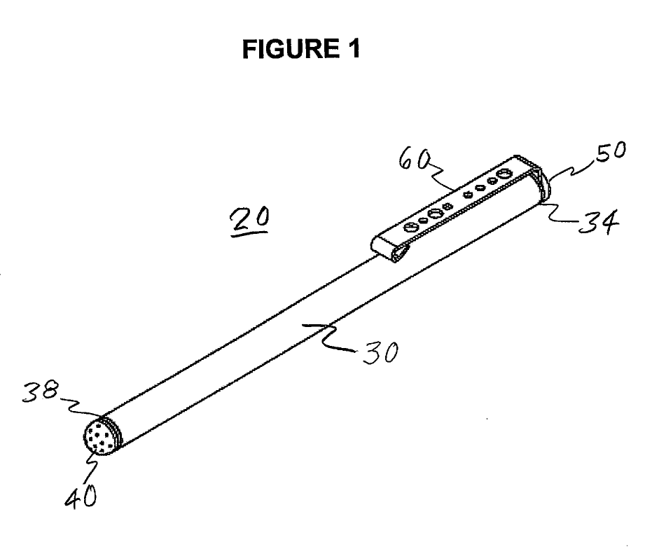

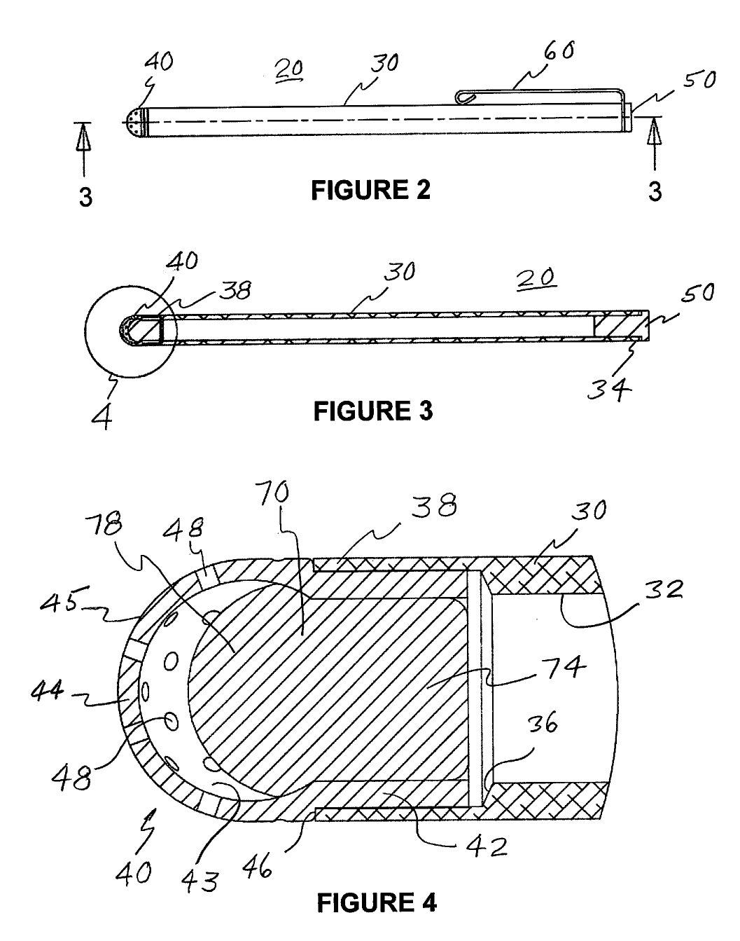

With reference to FIG. 1, a device 20 for inputting data to an electrically-sensitive user interface is shown in perspective. FIG. 2 is a side plan view of the device 20. The device 20 comprises a tubular body 30 having a proximal end 34 and a distal end 38, an interface-contacting member 40 affixed to the distal end 38 of the body 30, a cap 50 affixed to the proximal end 34 of the body 30 and a pocket-clip 60 retained between the proximal end 34 of the body 30 and the cap 50. From the sectional view of FIG. 3, it will be seen that the cap 50 as well as the interface-contacting member 40 are received within the proximal end 34 and the distal end 38, respectively, of the tubular body 30. In certain embodiments, the cap 50 and the interface-contacting member 40 are retained by press-fitting them within the respective ends 34 and 38 of the body 30.

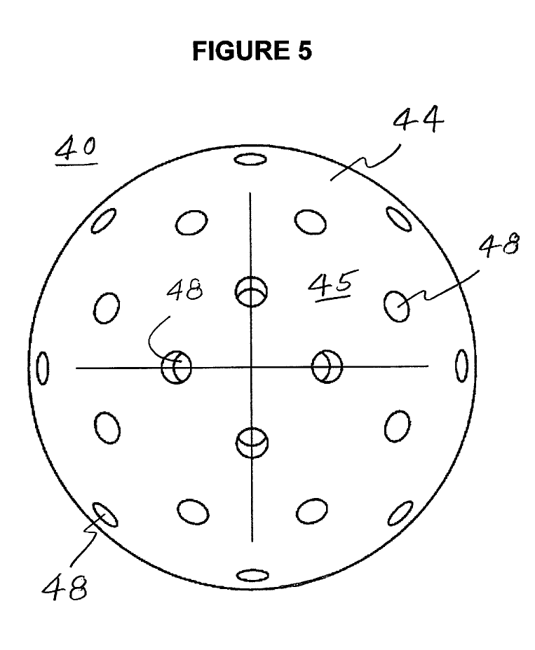

FIG. 4 provides an enlarged view of the distal end 38 of the tubular body 30 and interface-contacting member 40 in cross-section. A central portion 32 of the tubular body 30 has a relatively smaller inner diameter than that of the distal end 38, such that an inner shoulder 36 is formed where the central portion 32 is joined with the distal end 38. The interface-contacting member 40 comprises an inner cylindrical portion 42 and an outer, generally hemispherical portion 44 which form a shoulder 46 there between that abuts an outer edge of the distal end 38 of tubular body 30. With reference also to FIG. 5, a plurality of holes 48 extend from an outer surface 45 of the generally hemispherical portion 44 through an inner surface 43 thereof. Holes 48 are generally evenly distributed throughout portion 44.

A backing member 70 is positioned within the interface-contacting member 40, such that an inner cylindrical portion 74 of backing member 70 is held within inner cylindrical portion 42 of the interface-contacting member 40, while an outer cap 78 of backing member 70 is positioned within, and spaced from the inner surface 43 of the interface-contacting member 40. In those embodiments in which the interface-contacting member 40 is press-fit within the distal portion 38 of tubular body 30, backing member 70 compresses the inner cylindrical portion 42 of the interface-contacting member 40 against an inner wall of distal portion 38 to produce a secure frictional bond between the inner cylindrical portion 42 and the distal portion 38.

In use, the tubular body 30 of device 20 is held between the fingers of a user, much like a pen or pencil, with the distal end 38 of the body 30 and interface-contacting member 40 pointing towards an electrically-sensitive user interface of a data processing device (such as a computer, mobile telephone, hand-held data processing device, or the like). When the user has determined where to contact the user interface to input data, he or she presses the interface-contacting member 40 against its surface. Interface-contacting member 40 comprises a resilient material, so that its outer surface 45 deforms when pressed against the surface of the electrically-sensitive user interface in order to conform to such surface. The holes 48 in the outer, generally hemispherical portion 44 of the interface-contacting member 40 permit the resilient material to expand within such holes, thus facilitating deformation of the outer surface 45 to conform to the surface of the electrically-sensitive user interface. Accordingly, by adjusting the force used to press the interface-contacting member 40 against the surface of the user interface, the user can easily vary the area of contact between the interface-contacting member 40 and the surface of the interface in order to most precisely and comfortably achieve the desired response by the data processing device.

In certain embodiments, the outer, generally hemispherical portion 44 of the interface-contacting member 40 is provided with one or more indentations which do not extend entirely through the portion 44, while in other embodiments the indentations extend entirely there-through. In certain embodiments, the interface-contacting member 40 is solid, rather than hollow. In certain embodiments, the portion 44 is convex, but not hemispherical. For example, in certain ones of such embodiments portion 44 has a generally elliptical, hyperbolic, parabolic or multifaceted shape.

In those embodiments of the device 20 configured to input data to an electrically-sensitive user interface which senses the presence of a capacitively-coupled load, ground or signal source in order to input data, interface-contacting member 40 comprises either an electrically conductive or electrically semiconductive material in order to form a plate of a capacitor when pressed against a surface of the electrically-sensitive user interface. In certain ones of such embodiments, the interface-contacting member 40 comprises rubber or resilient plastic having carbon or other electrically conductive or semiconductive particles embedded therein, or comprises a nonconductive material coated with an electrically-conductive or semiconductive material. In other embodiments, the interface-contacting member 40 may comprise an electrically-conductive or semiconductive material with a non-conductive coating used, for example, to adjust the coefficient of friction, add color, or add texture. In such an embodiment, the non-conductive coating must be thin enough and/or comprise a high enough relative permittivity to allow for an adequate signal to be conducted by the electrically-conductive or semiconductive material. The interface-contacting member 40 may be produced, for example, by injection molding. In certain ones of such embodiments in which the user's body serves as a load, ground or signal source for inputting data to the interface, the tubular body 30 is made of an electrically-conductive or semiconductive material, for example, aluminum or other metal, such that it is electrically coupled to the interface-contacting member 40 and to the user's body through his or her fingers. In certain ones of such embodiments in which the tubular body 30 is made of an electrically-conductive or semiconductive material, this material is covered by a non-conductive material, such as a coating produced by anodizing a metal. In certain ones of such embodiments, the tubular body 30 is made of a non-conductive material coated with an electrically-conductive or semiconductive material.

In the illustrated embodiments, the backing member 70 serves to support the inner surface 43 of the outer, generally hemispherical portion 44 of interface-contacting member 40 as it is deformed inwardly by pressure against the surface of the interface. Holes 48 in the portion 44 also serve to permit air from between the portion 44 and the backing member 70 to escape when this occurs. Backing member 70 advantageously comprises a relatively harder material than the resilient material of member 40, so that in certain embodiments backing member 70 comprises ABS or other hard plastic.

Although various embodiments have been described with reference to a particular arrangement of parts, features and the like, these are not intended to exhaust all possible arrangements or features, and indeed many other embodiments, modifications and variations will be ascertainable to those of skill in the art.

What is claimed is:

1. A device for inputting data to an electrically-sensitive user interface, comprising: a device body; and
an interface contacting member supported by the body;
the interface-contacting member comprising a resilient material having a continuous convex interface-contacting surface;
the interface-contacting surface having at least one recess formed therein.

2. The device of claim 1, wherein the interface-contacting surface has a plurality of spaced-apart recesses formed therein.

3. The device of claim 2, wherein the plurality of spaced-apart recesses are evenly distributed over the interface-contacting surface.

4. The device of claim 1, wherein the resilient material is one of electrically conductive and electrically semiconductive.

5. The device of claim 4, wherein the device body comprises a material which is one of electrically conductive and electrically semiconductive, and the interface-contacting member is electrically coupled with the device body.

6. The device of claim 1, wherein the interface-contacting member has an inner wall defining a hollow interior.

7. The device of claim 6, wherein the at least one recess extends through the inner wall of the interface-contacting member.

8. The device of claim 6, comprising a backing member positioned within the hollow interior of the interface-contacting member and having an outer surface facing and spaced from the inner wall of the interface contacting member.

9. The device of claim 8, wherein the at least one recess extends through the inner wall of the interface-contacting member.

10. The device of claim 8, wherein the outer surface of the backing member is shaped to conform to a shape of the inner wall of the interface contacting member.

11. The device of claim 8, wherein the interface-contacting member is positioned within a recess of the device body and the backing member is positioned within the hollow interior of the interface-contacting member such that the interface-contacting member is pressed against an inner wall of the recess by the backing member.

12. A process for inputting data to an electrically-sensitive user interface, comprising: providing a device having a device body and an electrically-sensitive contacting member supported by the body, the electrically-sensitive contacting member comprising a resilient material having a continuous convex interface-contacting surface having at least one recess formed therein; pressing the interface-contacting surface of the electrically-sensitive contacting member against a surface of an electrically-sensitive user interface such that the resilient material of the electrically-sensitive contacting member is compressed into the recess thus facilitating deformation of the interface-contacting surface to conform to the surface of the electrically-sensitive user interface; and inputting data to the electrically-sensitive user interface through an electrical interaction of the interface-contacting surface of the electrically-sensitive contacting member with the surface of the electrically-sensitive user interface.

13. The process of claim 12, wherein the convex interface-contacting surface has a plurality of recesses formed therein, and pressing the interface-contacting surface of the electrically-sensitive contacting member against a surface of an electrically-sensitive user interface comprises compressing the resilient material of the electrically-sensitive contacting member into the plurality of recesses.

14. The process of claim 12, wherein the interface-contacting member has an inner wall defining a hollow interior and the at least one recess extends through the inner wall of the interface-contacting member, and pressing the interface-contacting surface of the electrically-sensitive contacting member against a surface of an electrically-sensitive user interface comprises expelling air within the hollow interior of the interface-contacting member outwardly thereof through the at least one recess.

15. The process of claim 12, wherein the interface-contacting member has an inner wall defining a hollow interior and the device comprises a backing member positioned within the hollow interior of the interface-contacting member, and pressing the interface-contacting surface of the electrically-sensitive contacting member against a surface of an electrically-sensitive user interface comprises supporting the inner wall of the interface-contacting member against an outer surface of the backing member.
